(19) United States
(12) Patent Application Publication
(10) Pub. No.: US 2026/0092661 A1
(43) Pub. Date: Apr. 2, 2026

(54) PRESS-FIT LEAKAGE-PROOF PIPELINE CONNECTION STRUCTURE

(71) Applicant: TAIZHOU JINQUAN COPPER INCORPORATED COMPANY, YUHUAN (CN)

(72) Inventor: CAIYOU SUN, YUHUAN (CN)

(21) Appl. No.: 18/978,503

(22) Filed: Dec. 12, 2024

(30) Foreign Application Priority Data
Sep. 29, 2024 (CN) 202422389736.4

(51) Int. Cl. F16L 37/098

(52) U.S. Cl. CPC F16L 37/098

(57) ABSTRACT

Disclosed is a press-fit leakage-proof pipeline connection structure, belonging to the technical field of pipeline sealing. The present disclosure includes a press fitting, a connecting pipe and a sealing ring. At least one end of the press fitting has a mouth, an inner wall of the mouth has a U-shaped groove, a bulge is formed in an outer wall of the press fitting, the sealing ring is elastic and is arranged in the U-shaped groove, and the connecting pipe is inserted into the mouth. The sealing ring has long arc segments and short arc segments that are connected into a ring. The bulge is pressed to deform, and the U-shaped groove squeezes the sealing ring, so that inner surfaces of the long arc segments and the short arc segments are closely attached to an outer wall of the connecting pipe, thereby realizing sealing.

### TECHNICAL FIELD

The present disclosure belongs to the technical field of pipeline sealing, and in particular to a press-fit leakage-proof pipeline connection structure.

### BACKGROUND

The working principle of a press fitting is as follows: a thin-walled metal connecting pipe is inserted into an end of the press fitting, a pressing tool is used to make the connecting pipe securely fastened by the press fitting, and the gap between the connecting pipe and the press fitting is sealed by a sealing ring so that the press fitting has the characteristics of leakage resistance, pull-out resistance, vibration resistance and high pressure resistance. The press fitting not only reduces the complexity of the conventional pipeline connection, but also improves the connection efficiency and durability, and it is mainly applied to water, oil, gas and other pipeline systems.

Chinese patent No. CN2753939Y discloses a press fitting, including a fitting body and an O-shaped sealing ring. An end of the fitting body has at least one mouth, a tail end of an outer side of the mouth has a ring-shaped dovetail groove protruding outward along a circumferential direction, and the O-shaped sealing ring is mounted in the dovetail groove. During mounting, the connecting pipe is inserted into the mouth, then a special clamp presses the dovetail groove and a pressing position outside the fitting body at the same time so that the dovetail groove reduces its diameter and presses the sealing ring against the outer wall of the connecting pipe, and the dovetail groove and the fitting body are subjected to compressional deformation at the same time to perform positioning and fixing functions.

As for the special clamp, Chinese patent No. CN106151707A discloses a pipe connection method and a special clamp. The special clamp a grip segment and a jaw segment, and a jaw cross section of the jaw segment is provided with a trapezoidal notch. When the special clamp is in use, the jaw segment clamps the ring-shaped groove along the axial direction, so that the ring-shaped groove undergoes permanent deformation and forces the sealing ring to press against an outer wall of a first fitting. Therefore, the sealing ring seals gap between the first fitting and a second fitting while the first fitting and the second fitting are pressed together.

After the connecting pipe is inserted into the fitting body of the press fitting, the gap between the fitting body and the connecting pipe is directly sealed by the O-shaped sealing ring. In large-scale pipeline engineering, there are a large number of fittings that need a press fit, producing a high workload. There is little difference in appearance before and after the press fit of the fitting body, so the workers may easily miss the pressing operation between some fitting bodies and the connecting pipes. Due to the presence of the O-shaped sealing ring, even if there is no pressing operation, the press fitting is watertight and leakage-proof within a short time. If the missed pressing position cannot be detected and remedied in time during the pressure test, there will be leakage during subsequent use, causing huge economic loss. Besides, an unsatisfactory pressing operation will also reduce the airtightness of the joint between the fitting body and the connecting pipe. During the pressure test, it is also difficult to accurately detect the unqualified pipeline joints, and it is difficult to detect the leakage positions when the existing sealing rings are used.

### SUMMARY

An objective of the present disclosure is to provide a press-fit leakage-proof pipeline connection structure with regard to the above problem in the prior art. The technical problem to be solved by the present disclosure is how to determine whether the gap between the press fitting and the connecting pipe is completely sealed during the pressure test.

The above technical objective of the present disclosure can be achieved by the following technical solution:

A press-fit leakage-proof pipeline connection structure includes a press fitting, a connecting pipe and a sealing ring. At least one end of the press fitting has a mouth, an inner wall of the mouth has a U-shaped groove, a bulge is formed in an outer wall of the press fitting, the sealing ring is elastic and is arranged in the U-shaped groove, and the connecting pipe is inserted into the mouth. The sealing ring has long arc segments and short arc segments that are connected into a ring. At least one long arc segment and at least one short arc segment are provided. A support point I and a support point II are formed at two ends of each of the short arc segments, and an inner surface of the short arc segment has an arc-shaped groove. The support point I and the support point II are configured to abut against an outer wall of the connecting pipe, and a ventilation gap I is formed between the arc-shaped groove and the connecting pipe. The bulge is pressed to deform, and the U-shaped groove squeezes the sealing ring, so that inner surfaces of the long arc segments and the short arc segments are closely attached to the outer wall of the connecting pipe, thereby sealing gaps between the connecting pipe and the press fitting.

According to the above technical solution, the U-shaped groove limits the sealing ring, and after the connecting pipe is inserted into the mouth, the support point I and support point II abut against the outer wall of the connecting pipe. After the press fitting is pressed using a clamp, the outer wall of the press fitting and the bulge undergo permanent deformation, the sealing ring is also squeezed to deform by the U-shaped groove, and the ventilation gaps I disappear, so that the inner sides of the long arc segments and the short arc segments are closely attached to the outer wall of the connecting pipe. Before the press fitting is pressed by the clamp, the ventilation gap I between the arc-shaped groove and the connecting pipe is in a sustained state, i.e., the arc-shaped groove of the short arc segment is not closely attached to the outer wall of the connecting pipe. In this case, the sealing ring does not completely seal the gaps between the connecting pipe and the press fitting. If a pressure or water supply test is performed on the press fitting or the connecting pipe, there will be leakage at the ventilation gaps I. In this case, the worker can determine whether the press fitting has been pressed by the clamp, and also determine whether the gaps between the press fitting and the connecting pipe are completely sealed. Therefore, the positions that have not been pressed can be remedied, thereby eliminating hidden danger.

In the above press-fit leakage-proof pipeline connection structure, the long arc segments have a radius of R1, the short arc segments have a radius of R2, and R1>R2. The radius of the long arc segments is greater than the radius of the short arc segments, that is, a curvature of the long arc segments is less than a curvature of the short arc segments, which makes the transition between the long arc segment and the short arc segment smoother and ensures the presence of the arc-shaped groove.

In the above press-fit leakage-proof pipeline connection structure, an outer side of each of the short arc segments has a bump protruding outward, and the bump abuts against the U-shaped groove, so that an interval is formed between an outer wall of each of the long arc segments and the U-shaped groove. The bump abuts against a wall of the U-shaped groove, so that the interval is formed between the outer wall of the long arc segment and the U-shaped groove. The interval can provide a space for the sealing ring to deform.

In the above press-fit leakage-proof pipeline connection structure, the support point I and the support point II are both close to an inner side of the short arc segment, the support point I and the support point II are arranged symmetrically, the support point I has a rounded corner I, and the support point II has a rounded corner II. The support point I abuts against the connecting pipe through the rounded corner I, and the support point II abuts against the connecting pipe through the rounded corner II, which reduces the contact area between the support point I/support point II and the outer wall of the connecting pipe, thereby reducing the sliding friction between the sealing ring and the outer wall of the connecting pipe during the deformation of the sealing ring, and ensuring the long arc segments and the short arc segments to easily deform and be closely attached to the connecting pipe.

In the above press-fit leakage-proof pipeline connection structure, the support point I and the support point II abut against the outer wall of the connecting pipe, and a ventilation gap II is kept between each of the long arc segments and the connecting pipe. With the cooperation between the ventilation gaps I and the ventilation gaps II, before the press fitting is pressed, there are sufficient gaps for the testing gas or fluid to pass through, thereby improving the accuracy of the pressure test.

In the above press-fit leakage-proof pipeline connection structure, the long arc segments and the short arc segments have circular cross sections, and the long arc segments and the short arc segments are integrally formed. The long arc segments and the short arc segments are integrally formed, thereby forming the ring-shaped sealing ring, and making the transition at the joint between the long arc segment and the short arc segment smooth.

In the above press-fit leakage-proof pipeline connection structure, at least three long arc segments and at least three short arc segments are provided, and the long arc segments and the short arc segments are respectively distributed at intervals. The arrangement of multiple short arc segments and long arc segments can increase the number of the ventilation gaps I, thereby further improving the performance of the sealing ring in the pressure test. Moreover, the amplitude of deformation of the sealing ring is more uniform, which helps to improve the sealing performance of the sealing ring.

In the above press-fit leakage-proof pipeline connection structure, the long arc segments and the short arc segments have a same thickness. An upper end surface and a lower end surface of the sealing ring are respectively on a same level, so that the sealing performance of the sealing ring will not be affected after the whole sealing ring deforms.

In the above press-fit leakage-proof pipeline connection structure, snap-fit teeth are arranged in the mouth, the snap-fit teeth are close to the U-shaped groove, and the press fitting is pressed to deform so that the snap-fit teeth tightly snap into the outer wall of the connecting pipe. After the press fitting is pressed by the clamp, the press fitting drives the snap-fit teeth to undergo permanent deformation so that the snap-fit teeth tightly snap into the outer wall of the connecting pipe, thereby improving the quality of connection between the press fitting and the connecting pipe.

In the above press-fit leakage-proof pipeline connection structure, the outer wall of the connecting pipe is provided with a snap-fit groove, the snap-fit groove is close to the U-shaped groove, and after the sealing ring deforms, the inner surfaces of the long arc segments and the short arc segments are pressed into the snap-fit groove. The sealing ring contacts the connecting pipe through the snap-fit groove, which can further increase the contact area between the sealing ring and the connecting pipe, thereby improving the sealing effect.

Based on the above, compared with the prior art, the present disclosure has the following beneficial effects:

After the connecting pipe is inserted into the mouth, the surfaces of the arc-shaped grooves and the long arc segments are not closely attached to the outer wall of the connecting pipe, and the ventilation gaps I and the ventilation gaps II are in a sustained state. In this case, the sealing ring does not completely seal the gaps between the connecting pipe and the press fitting. If a pressure or water supply test is performed on the press fitting or the connecting pipe, there will be leakage at the ventilation gaps I and the ventilation gaps II. In this case, the worker can determine whether the press fitting has been pressed by the clamp, and also determine whether the gaps between the press fitting and the connecting pipe are completely sealed by the sealing ring. Therefore, before the pipeline is put into use, the positions that have not been pressed can be remedied, thereby eliminating hidden danger. The present disclosure makes the test accurate and convenient during mounting, and ensures reliable construction quality. Moreover, after the press fitting is pressed using the clamp, the outer wall of the press fitting and the bulge undergo permanent deformation, the sealing ring is also squeezed to deform by the U-shaped groove, so that the inner surfaces of the long arc segments and the short arc segments are closely attached to the outer wall of the connecting pipe, and the ventilation gaps I and the ventilation gaps II disappear. In this case, the sealing ring completely seals the gaps between the connecting pipe and the press fitting. By arranging the sealing ring, whether there is leakage at the sealing ring can be determined by means of the pressure test before the press fitting is pressed, and the sealing quality between the press fitting and the connecting pipe can be ensured after the press fitting is pressed.

### BRIEF DESCRIPTION OF FIGURES

FIG. 1 is a schematic structural exploded view of an embodiment;

FIG. 2 is a schematic cross-sectional view of FIG. 1;

FIG. 3 is a schematic structural view of a sealing ring;

FIG. 4 is a schematic cross-sectional view I of FIG. 3;

FIG. 5 is a schematic cross-sectional view II of FIG. 3;

FIG. 6 is a schematic assembled structural view of FIG. 1;

FIG. 7 is another schematic cross-sectional view of an embodiment;

FIG. 8 is a schematic assembled structural view of an embodiment;

FIG. 9 is a schematic structural view of a connecting pipe;

FIG. 10 is a schematic assembled structural view of an embodiment;

FIG. 11 is a schematic exterior structural view of an embodiment; and

FIG. 12 is a schematic cross-sectional view of FIG. 11.

Reference numerals: 100, press fitting; 110, mouth; 111, U-shaped groove; 112, snap-fit tooth; 120, bulge; 130, coupling;

200, connecting pipe; 210, snap-fit groove;

300, sealing ring; 310, long arc segment; 320, short arc segment; 321, support point I; 3211, rounded corner I; 322, support point II; 3221, rounded corner II; 323, arc-shaped groove; 324, bump;

400, ventilation gap I; 500, ventilation gap II; and 600, interval.

### DETAILED DESCRIPTION

The technical solution of the present disclosure will be further described with reference to specific embodiments of the present disclosure and accompanying drawings, but the present disclosure is not limited to these embodiments.

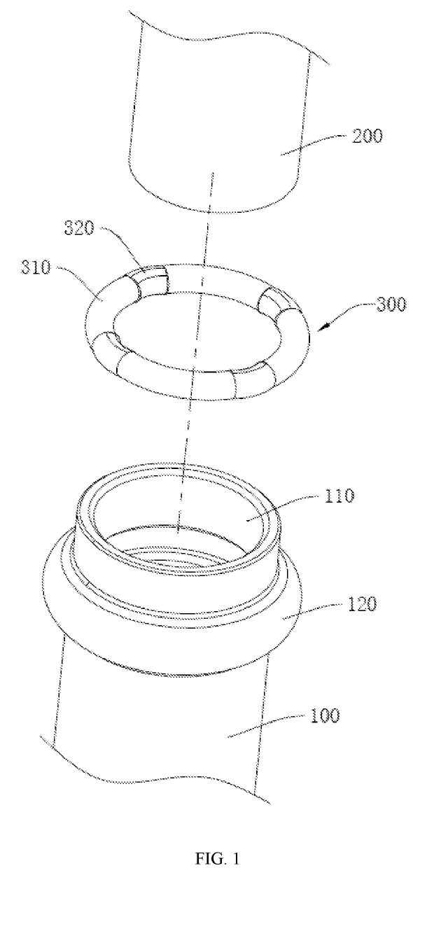

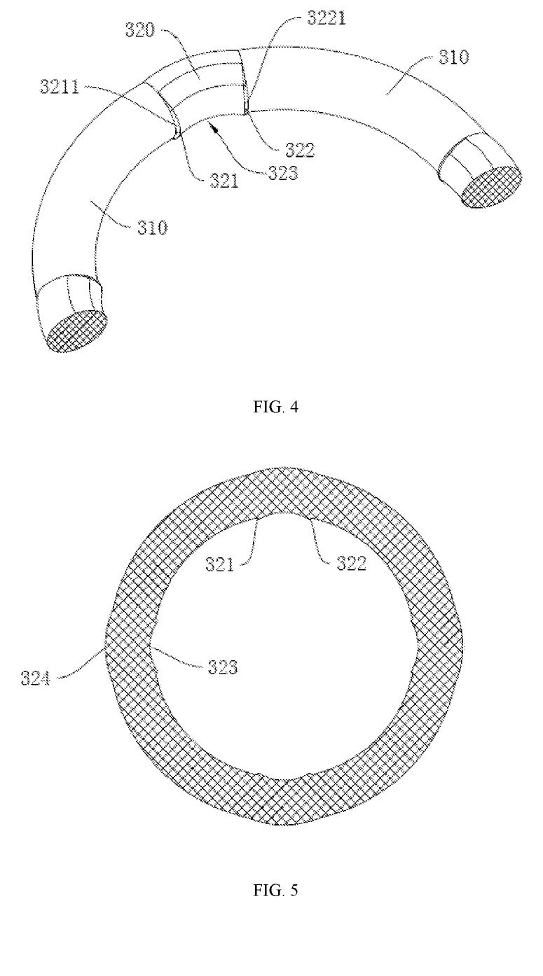

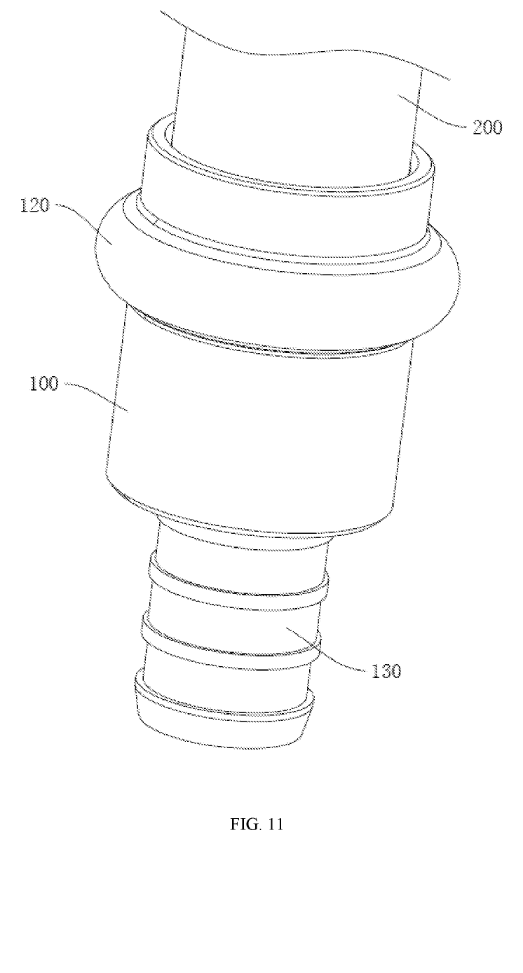

A press-fit leakage-proof pipeline connection structure, as shown in FIG. 1 to FIG. 12, includes a press fitting 100, a connecting pipe 200 and a sealing ring 300. At least one end of the press fitting 100 has a mouth 110, an inner wall of the mouth 110 has a U-shaped groove 111, a bulge 120 is formed in an outer wall of the press fitting 100 close to the U-shaped groove 111, the sealing ring 300 is elastic and is arranged in the U-shaped groove 111, and the connecting pipe 200 is inserted into the mouth 110. The sealing ring 300 has long arc segments 310 and short arc segments 320 that are connected into a ring. At least one long arc segment 310 and at least one short arc segment 320 are provided. A support point I 321 and a support point II 322 are formed at two ends of each of the short arc segments 320, and an inner surface of the middle of the short arc segment 320 has an arc-shaped groove 323. The support point I 321 and the support point II 322 are configured to abut against an outer wall of the connecting pipe 200, and a ventilation gap I 400 is formed between the arc-shaped groove 323 and the connecting pipe 200. The bulge 120 undergoes permanent deformation after being pressed by a clamp, and the U-shaped groove 111 squeezes the sealing ring 300, so that inner surfaces of the long arc segments 310 and the short arc segments 320 are closely attached to the outer wall of the connecting pipe 200, thereby sealing gaps between the connecting pipe 200 and the press fitting 100.

As shown in FIG. 1 to FIG. 8, the long arc segments 310 and the short arc segments 320 have circular cross sections, and the long arc segments 310 and the short arc segments 320 have a same thickness. In other words, upper surfaces of the long arc segments 310 and the short arc segments 320 are on a same level, and lower surfaces of the long arc segments 310 and the short arc segments 320 are also on a same level.

The long arc segments 310 have a radius of R1, the short arc segments 320 have a radius of R2, and R1>R2. According to the law that the smaller the circle, the greater the curvature, and the larger the circle and the smaller the curvature, in this embodiment, a curvature of an arc length of the long arc segment 310 is less than a curvature of an arc length of the short arc segment 320, so that the arc-shaped groove 323 is naturally formed between the support point I 321 and the support point II 322. Moreover, the arc-shaped groove 323 is smoother, and the joint between the long arc segment 310 and the short arc segment 320 is smoother, thereby ensuring the arc-shaped groove 323 to be closely attached to the outer wall of the connecting pipe 200.

An outer side of each of the short arc segments 320 has a bump 324 protruding outward, and the bump 324 is configured to abut against a side wall of the U-shaped groove 111, so that an interval 600 is formed between an outer wall of each of the long arc segments 310 and the U-shaped groove 111. The interval 600 provides a space for the sealing ring 300 to deform.

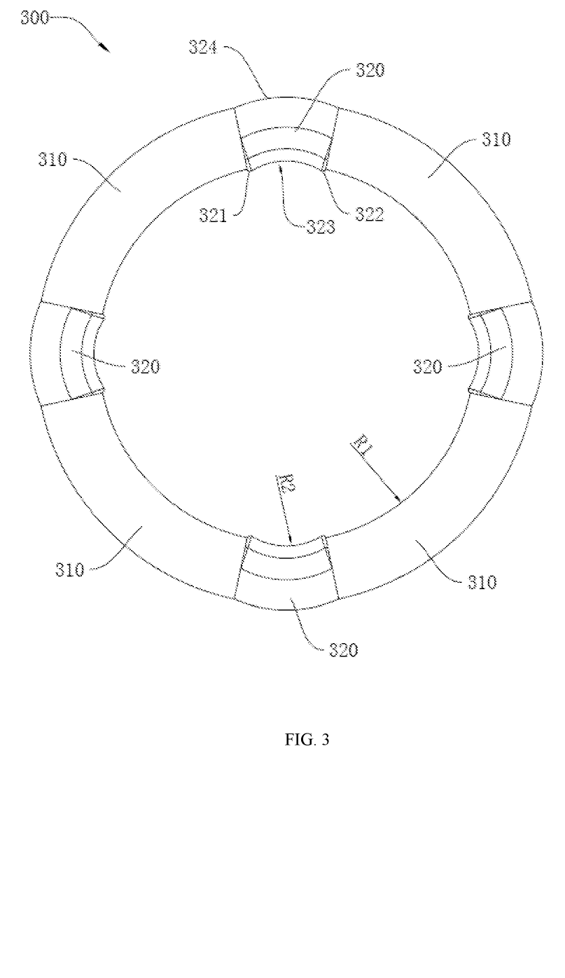

As shown in FIG. 3 to FIG. 5, the support point I 321 and the support point II 322 are both close to an inner side of the short arc segment 320, the support point I 321 and the support point II 322 are arranged symmetrically, the support point I 321 has a rounded corner I 3211, and the support point II 322 has a rounded corner II 3221. The support point I 321 abuts against the outer wall of the connecting pipe 200 through the rounded corner I 3211, and the support point II 322 abuts against the outer wall of the connecting pipe 200 through the rounded corner II 3221.

The support point I 321 and the support point II 322 abut against the outer wall of the connecting pipe 200, so that a ventilation gap II 500 is kept between each of the long arc segments 310 and the connecting pipe 200. The ventilation gaps I 400 and the ventilation gaps II 500 are available for the testing gas or water to pass through, thereby improving the accuracy of the test.

At least three long arc segments 310 and at least three short arc segments 320 are provided, and the long arc segments 310 and the short arc segments 320 are respectively distributed at intervals. In at least one embodiment, four long arc segments 310 and four short arc segments 320 are provided. The long arc segments 310 and the short arc segments 320 are integrally formed, so that the sealing ring 300 is capable of elastic deformation. The long arc segments 310 and the short arc segments 320 are made of one or more of polytetrafluoroethylene, nitrile-butadiene rubber and silicone rubber.

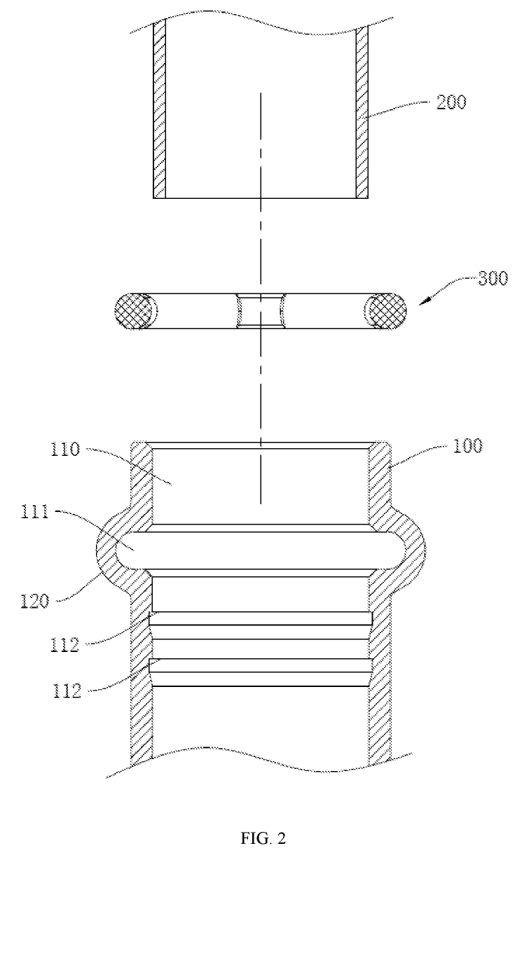

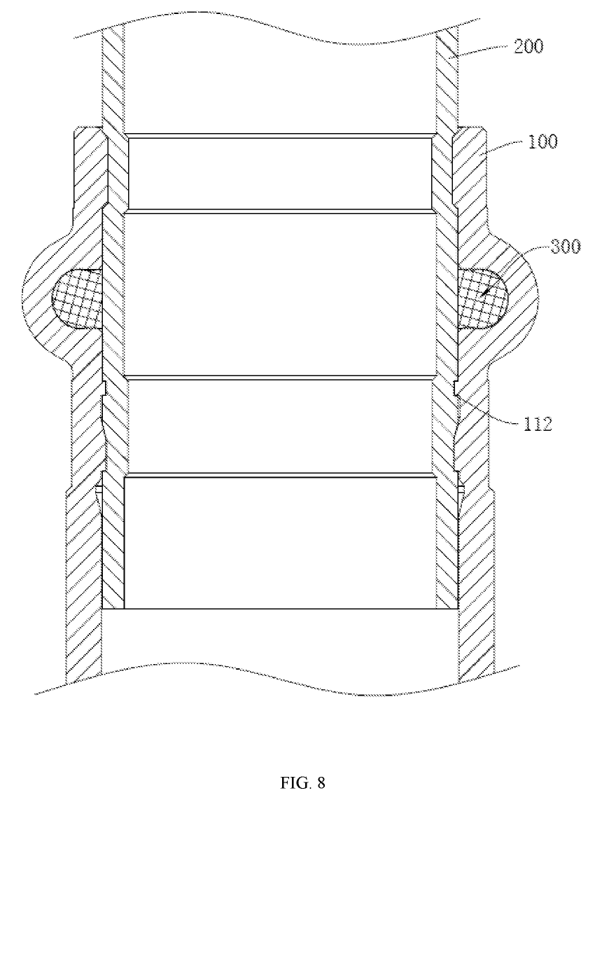

As shown in FIG. 2 and FIG. 8, snap-fit teeth 112 are arranged in the mouth 110, the snap-fit teeth 112 are close to the U-shaped groove 111, and the press fitting 100 is pressed to deform so that the snap-fit teeth 112 tightly snap into the outer wall of the connecting pipe 200, thereby preventing the connecting pipe 200 from coming out of the mouth 110.

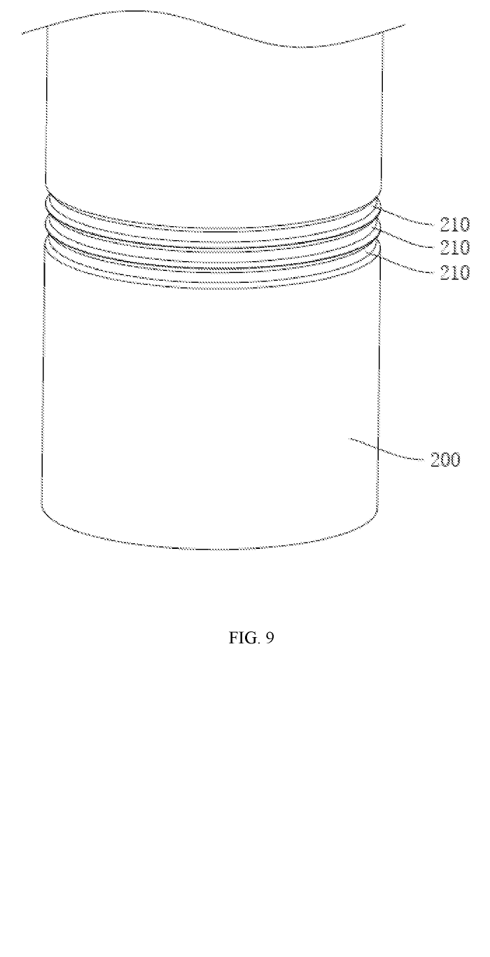

As shown in FIG. 9 to FIG. 12, as another solution, the outer wall of the connecting pipe 200 is provided with a snap-fit groove 210, the snap-fit groove 210 is ring-shaped, the snap-fit groove 210 is close to the U-shaped groove 111, and after the sealing ring 300 deforms, the inner surfaces of the long arc segments 310 and the short arc segments 320 are pressed into the snap-fit groove 210, thereby increasing the contact area between the sealing ring 300 and the outer wall of the connecting pipe 200. There may be multiple snap-fit grooves 210 arranged at intervals. In some implementations, the snap-fit groove 210 may also be replaced with a threaded groove.

An end of the press fitting 100 away from the mouth 110 is provided with a coupling 130, and the coupling 130 may be used to be connected to another pipeline.

The working principle of the present disclosure is as follows:

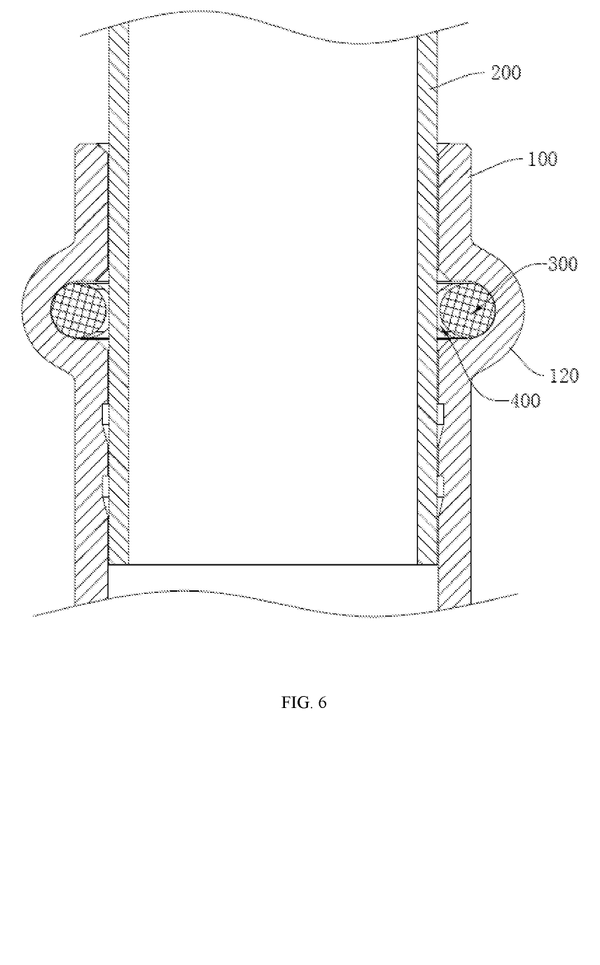

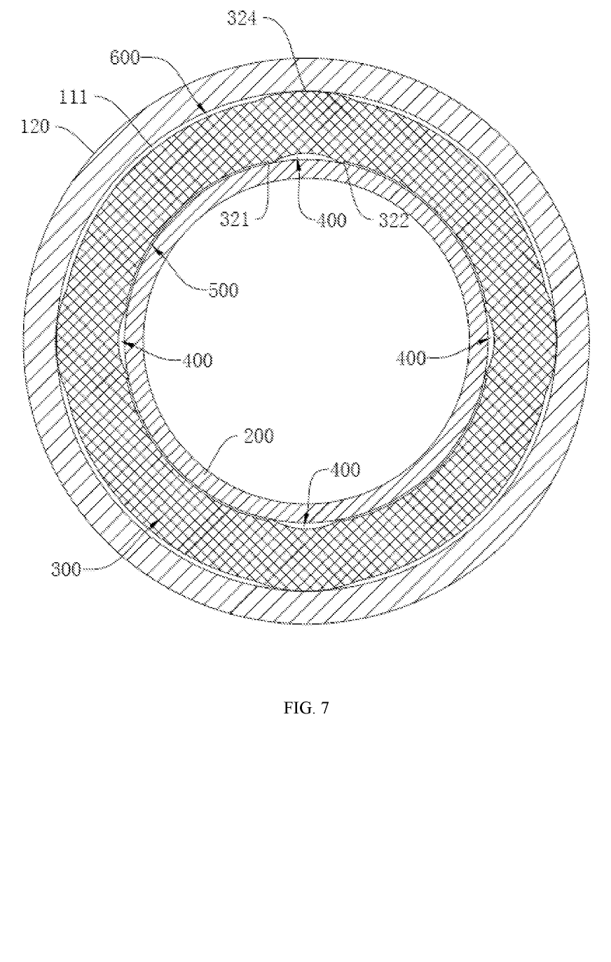

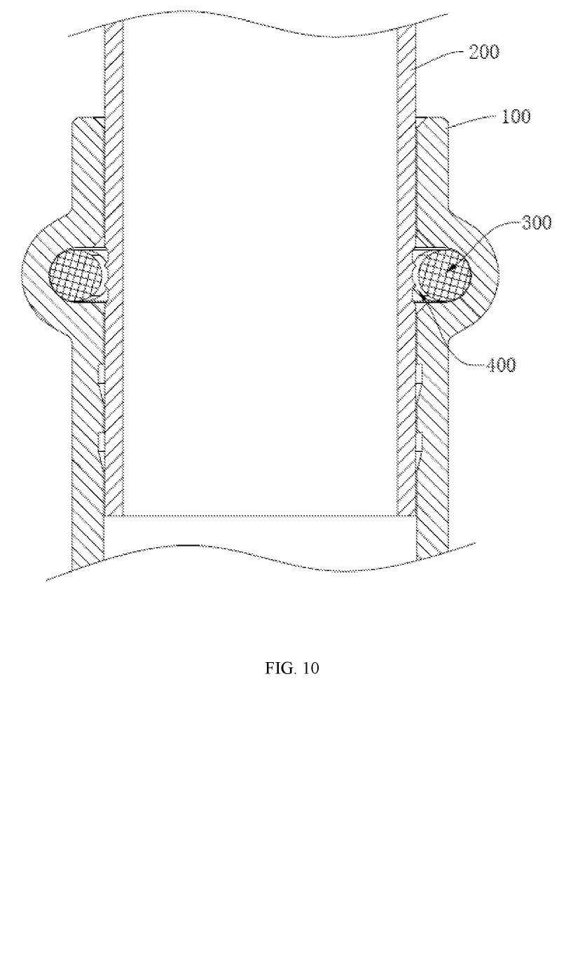

As shown in FIG. 6, FIG. 7 and FIG. 10, before the press fitting 100 and the connecting pipe 200 are connected, the sealing ring 300 is mounted into the U-shaped groove 111, so that the U-shaped groove 111 limits the sealing ring 300. After the connecting pipe 200 is inserted into the mouth 110, the support point I 321 and the support point II 322 of each short arc segment 320 abut against the outer wall of the connecting pipe 200. Before the press fitting 100 is pressed by the clamp (or calipers), the inner surfaces of the long arc segments 310 and the short arc segments are not closely attached to the outer wall of the connecting pipe 200, the ventilation gaps I 400 and the ventilation gaps II 500 are sustained. In this case, the sealing ring 300 has not sealed the gaps between the connecting pipe 200 and the press fitting 100. As long as a pressure or water supply test is performed on the press fitting 100 or the connecting pipe 200, there will be leakage at the ventilation gaps I 400 and the ventilation gaps II 500. In this case, the worker can determine whether the press fitting 100 has been pressed by the clamp, and also determine whether the gaps between the press fitting 100 and the connecting pipe 200 are completely sealed by the sealing ring 300. Therefore, before the pipeline is put into use, the positions that have not been pressed can be remedied, thereby eliminating hidden danger.

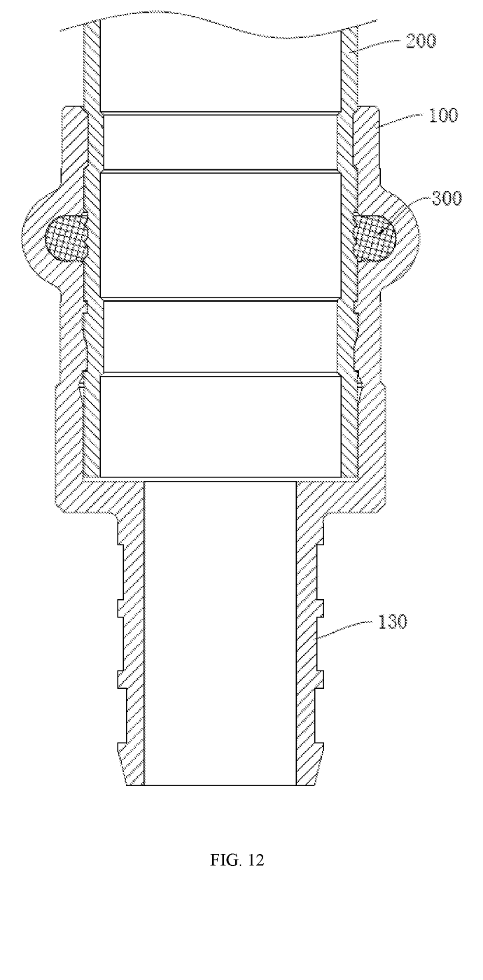

As shown in FIG. 8 and FIG. 12, after the press fitting 100 is pressed using the clamp, the outer wall of the press fitting 100 and the bulge 120 undergo permanent deformation toward a central axis of the press fitting 100, the sealing ring 300 is also squeezed to deform by the U-shaped groove 111, the U-shaped groove 111 is filled with the sealing ring 300, and the ventilation gaps I 400 and the ventilation gaps II 500 disappear, so that the inner surfaces of the long arc segments 310 and the short arc segments 320 are closely attached to the outer wall of the connecting pipe 200, and outer surfaces of the long arc segments 310 and the short arc segments 320 are closely attached to the side wall of the U-shaped groove 111. In this case, the sealing ring 300 completely seals the gaps between the connecting pipe 200 and the press fitting 100. At the same time, the snap-fit teeth 112 snap into the outer wall of the connecting pipe 200, and so that the connecting pipe 200 cannot be pulled out of the mouth 110, thereby completing the connection between the press fitting 100 and the connecting pipe 200.

The specific embodiments described herein are merely illustrative of the spirit of the present disclosure. Those skilled in the art to which the present disclosure belongs can make various modifications or additions to the described specific embodiments or replace them in a similar manner without departing from the spirit of the present disclosure or going beyond the scope defined by the appended claims.

What is claimed is:

1. A press-fit leakage-proof pipeline connection structure, comprising: a press fitting (100), a connecting pipe (200) and a sealing ring (300), wherein at least one end of the press fitting (100) has a mouth (110), an inner wall of the mouth (110) has a U-shaped groove (111), a bulge (120) is formed in an outer wall of the press fitting (100), the sealing ring (300) is elastic and is arranged in the U-shaped groove (111), and the connecting pipe (200) is inserted into the mouth (110);
the sealing ring (300) has long arc segments (310) and short arc segments (320) that are connected into a ring, at least one long arc segment (310) and at least one short arc segment (320) are provided, a support point I (321) and a support point II (322) are formed at two ends of each of the short arc segments (320), an inner surface of the short arc segment (320) has an arc-shaped groove (323), the support point I (321) and the support point II (322) are configured to abut against an outer wall of the connecting pipe (200), a ventilation gap I (400) is formed between the arc-shaped groove (323) and the connecting pipe (200), the bulge (120) is pressed to deform, and the U-shaped groove (111) squeezes the sealing ring (300), so that inner surfaces of the long arc segments (310) and the short arc segments (320) are closely attached to the outer wall of the connecting pipe (200), thereby sealing gaps between the connecting pipe (200) and the press fitting (100).

2. The press-fit leakage-proof pipeline connection structure according to claim 1, wherein the long arc segments (310) have a radius of R1, the short arc segments (320) have a radius of R2, and R1>R2.

3. The press-fit leakage-proof pipeline connection structure according to claim 1, wherein an outer side of each of the short arc segments (320) has a bump (324) protruding outward, and the bump (324) abuts against the U-shaped groove (111), so that an interval (600) is formed between an outer wall of each of the long arc segments (310) and the U-shaped groove (111).

4. The press-fit leakage-proof pipeline connection structure according to claim 1, wherein the support point I (321) and the support point II (322) are both close to an inner side of the short arc segment (320), the support point I (321) and the support point II (322) are arranged symmetrically, the support point I (321) has a rounded corner I (3211), and the support point II (322) has a rounded corner II (3221).

5. The press-fit leakage-proof pipeline connection structure according to claim 4, wherein the support point I (321) and the support point II (322) abut against the outer wall of the connecting pipe (200), and a ventilation gap II (500) is kept between each of the long arc segments (310) and the connecting pipe (200).

6. The press-fit leakage-proof pipeline connection structure according to claim 1, wherein the long arc segments (310) and the short arc segments (320) have circular cross sections, and the long arc segments (310) and the short arc segments (320) are integrally formed.

7. The press-fit leakage-proof pipeline connection structure according to claim 6, wherein at least three long arc segments (310) and at least three short arc segments (320) are provided, and the long arc segments (310) and the short arc segments (320) are respectively distributed at intervals.

8. The press-fit leakage-proof pipeline connection structure according to claim 6, wherein the long arc segments (310) and the short arc segments (320) have a same thickness.

9. The press-fit leakage-proof pipeline connection structure according to claim 1, wherein snap-fit teeth (112) are arranged in the mouth (110), the snap-fit teeth (112) are close to the U-shaped groove (111), and the press fitting (100) is pressed to deform so that the snap-fit teeth (112) tightly snap into the outer wall of the connecting pipe (200).

10. The press-fit leakage-proof pipeline connection structure according to claim 1, wherein the outer wall of the connecting pipe (200) is provided with a snap-fit groove (210), the snap-fit groove (210) is close to the U-shaped groove (111), and after the sealing ring (300) deforms, the inner surfaces of the long arc segments (310) and the short arc segments (320) are pressed into the snap-fit groove (210).
